(19) United States
(12) Patent Application Publication
(10) Pub. No.: US 2024/0165884 A1
(43) Pub. Date: May 23, 2024

(54) ADDITIVE MANUFACTURING WITH CAST SELECTION

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Tushar Agrawal, West Fargo, ND (US); NARENDRA REDDY TIPPALA, Visakhapatnam (IN)

(21) Appl. No.: 18/056,742

(22) Filed: Nov. 18, 2022

(51) Int. Cl. B29C 64/393; B29C 64/245

(52) U.S. Cl. CPC B29C 64/393; B29C 64/245; B33Y 10/00

(57) ABSTRACT

A method for cast based hybrid additive manufacturing includes receiving a three-dimensional digital model file for construction of an object utilizing an additive manufacturing device. The method also includes receiving one or more additional requirements for the object and identifying, based on the three-dimensional digital model file and the one or more additional requirements for the object, a cast for the three-dimensional digital model file for integration into hybrid additive manufacturing of the object. The method also includes instructing, a secondary manufacturing device, to dispose the cast at a position with respect to a partially constructed object by the additive manufacturing device. The method also includes resuming the hybrid additive manufacturing of the partially constructed object with the cast until the construction of the object is complete.

### BACKGROUND

This disclosure relates generally to additive manufacturing, and in particular to cast selection for additive manufacturing.

Additive manufacturing utilizes a three-dimensional digital model file to create an object by constructing, commonly referred to as printing, one layer at a time until the object is formed. The additive process includes adding layers of material in a successive manner, where each layer represents a cross-sectional slice of the object being constructed. Additive manufacturing allows for complex shapes to be constructed and reduces an amount of milling and/or cutting needed to obtain a final form of the object being constructed. Casting is a manufacturing process that typically include pouring a material in liquid form into a mold, where the mold is a hollow cavity that provides the final form of the object.

### SUMMARY

Embodiments in accordance with the present invention disclose a method, computer program product and computer system for cast based hybrid additive manufacturing, the method, computer program product and computer system can receive a three-dimensional digital model file for construction of an object utilizing an additive manufacturing device. The method, computer program product and computer system can, responsive to receiving one or more additional requirements for the object, identify, based on the three-dimensional digital model file and the one or more additional requirements for the object, a cast for the three-dimensional digital model file for integration into hybrid additive manufacturing of the object. The method, computer program product and computer system can instruct, a secondary manufacturing device, to dispose the cast at a position with respect to a partially constructed object by the additive manufacturing device. The method, computer program product and computer system can resume the hybrid additive manufacturing of the partially constructed object with the cast until the construction of the object is complete.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a cast selection program for identifying and providing a cast during an additive manufacturing process of an object, in accordance with an embodiment of the present invention.

FIG. 3A depicts an illustrative example of an object constructed through additive manufacturing utilizing a solid cast portion, in accordance with an embodiment of the present invention.

FIG. 3B depicts an illustrative example of an object constructed through additive manufacturing utilizing a truss cast portion, in accordance with an embodiment of the present invention.

FIG. 4A depicts an illustrative example of an object being constructed utilizing an additive manufacturing device prior to selection of a solid cast portion, in accordance with an embodiment of the present invention.

FIG. 4B depicts an illustrative example of an object being constructed utilizing an additive manufacturing device subsequent to solid cast portion being selected and provided by a secondary industrial device, in accordance with an embodiment of the present invention.

FIG. 4C depicts an illustrative example of an object being constructed utilizing an additive manufacturing device to provide material around a solid cast portion, in accordance with an embodiment of the present invention.

FIG. 4D depicts an illustrative example of a complete object constructed utilizing an additive manufacturing device with a solid cast portion embedded in the object, in accordance with an embodiment of the present invention.

FIG. 5A depicts an illustrative example of an object being constructed utilizing a secondary manufacturing device to provide a truss cast portion to initialize construction of an object, in accordance with an embodiment of the present invention.

FIG. 5B depicts an illustrative example of an object being constructed utilizing an additive manufacturing device to provide material around a truss cast portion, in accordance with an embodiment of the present invention.

FIG. 5C depicts an illustrative example of an object being constructed utilizing an additive manufacturing device to further provide material around a truss cast portion, in accordance with an embodiment of the present invention.

FIG. 5D depicts an illustrative example of a complete object constructed utilizing an additive manufacturing device with a truss cast portion embedded in the object, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

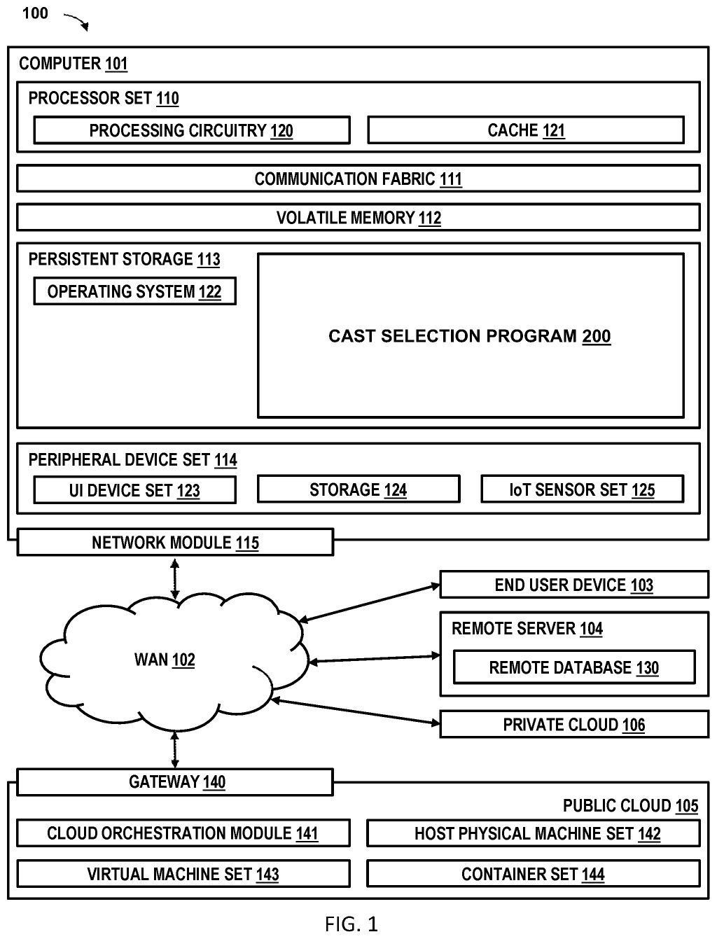

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as cast selection program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

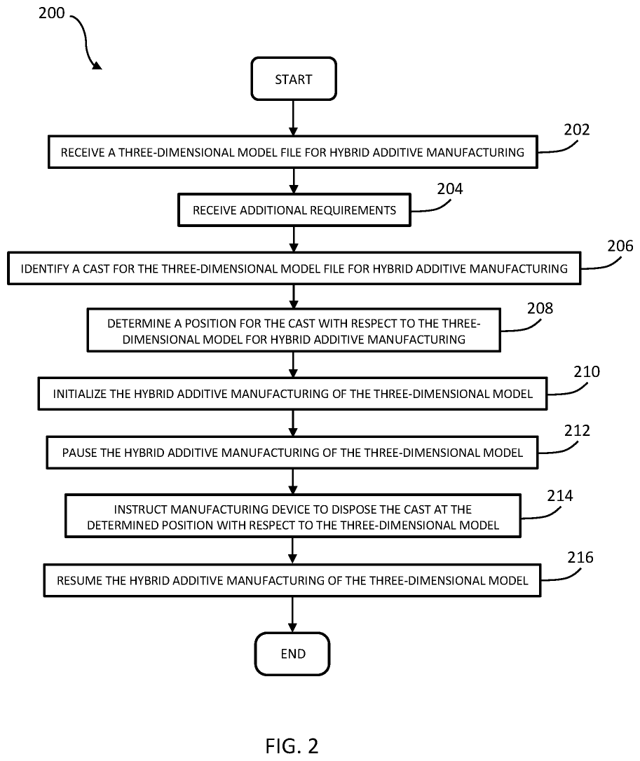

FIG. 2 depicts a flowchart of a cast selection program for identifying and providing a cast during an additive manufacturing process of an object, in accordance with an embodiment of the present invention.

Cast selection program 200 receives a three-dimensional model file for hybrid additive manufacturing (202). Hybrid additive manufacturing includes integrating a cast mass into an object being constructed with a primary device (e.g., three-dimensional printer) utilizing additive manufacturing, where a secondary device (e.g., manufacturing device) positions and disposes the cast mass for integration into the object. The three-dimensional model file is a mathematical coordinate-based representation for an internal and/or external surface of an object in three-dimensions defined along the x-axis, y-axis, and z-axis. The three-dimensional digital model can be created utilizing a computer-aided design (CAD) package, a three-dimension scanner of an existing object, and/or multiple digital images utilizing photogrammetry to extract three-dimensional measurements from two-dimensional data (i.e., the multiple digital images). In one embodiment, cast selection program 200 can receive a three-dimensional digital model file for hybrid additive manufacturing in the form of a stereolithography file format (STL) file or additive manufacturing file format (AMF) file, for a CAD model of an object. In another embodiment, cast selection program 200 can receive a three-dimensional model file for hybrid additive manufacturing in the form of a three-dimensional scan of an existing objecting utilizing a hand-held laser scanner, a structure-light three-dimensional scanner, or a modulated light three-dimensional scanner. In yet another embodiment, cast selection program 200 can receive a three-dimensional model file for hybrid additive manufacturing in the form of a three-dimensional model file generated by photogrammetry software for a scanned object, where the photogrammetric software can provide a necessary CAD model for the scanned object in the form of an STL file or AMF file.

Cast selection program 200 receives additional requirements for the object being constructed with the three-dimensional model file (204). Cast selection program 200 can receive (e.g., from a user) additional requirements for the object being constructed with the three-dimensional model file as it relates to an integration of a cast during the hybrid additive manufacturing process. In one embodiment, cast selection program 200 receives a three-dimensional model file for hybrid additive manufacturing and determines the hybrid additive manufacturing of the object without a cast requires 90 minutes. Cast selection program 200 can receive a user specified manufacturing time (e.g., 60 minutes) for the hybrid additive manufacturing of the object, where cast selection program 200 can utilize the user specified manufacturing when identifying a cast for the three-dimensional model file of the object. In another embodiment, cast selection program 200 receives a three-dimensional model file for hybrid additive manufacturing of a specialized tool and receives an additional requirement for the specialized tool to include a weighted portion to allow for more ergonomic handling when placed in a hand of a user. The weighted portion represents cast material for integration into the specialized tool during the hybrid additive manufacturing process. Cast selection program 200 also receives additional requirements that provide dimensions and a position for the weighted portion with respect to a body of the specialized tool.

In other embodiments, additional requirements can include but are not limited to weight limits, material types, material utilization limits, raw material cost limits, and structural integrity limits, for the object being constructed with the hybrid additive manufacturing process. The additional requirement specifying weight limits can include an overall weight limit for the object being constructed with the hybrid additive manufacturing process and/or a weight limit of a cast for integration into the object being constructed. The additional requirement specifying material type can include one or more material types for the object being constructed and/or one or more material types of a cast for integration into the object being constructed. The additional requirement specifying material utilization limits (e.g., x<50% thermoplastics) can include a material utilization limit of the object being constructed with the primary device and/or a material utilization limit (e.g., x≥50% aluminum) of a cast for integration into the object being constructed. The additional requirement specifying raw material cost limits can include an overall raw material cost limit of the object being constructed with the hybrid additive manufacturing process, a raw material cost limit of the object constructed with the additive manufacturing process, and/or a raw material cost limit of a cast for integration into the object being constructed. The additional requirement specifying structural integrity limits can include stress limit values for the object being constructed, stress limit values for the cast being integrated into the object, and stress limit values where portions of the object contact portions of the cast being integrated into the object.

Cast selection program 200 identifies a cast for the three-dimensional model file for hybrid additive manufacturing (206). Based on dimensions of the object being constructed, a shape of the object being constructed, and any received additional requirements from (204), cast selection program 200 identifies a cast for three-dimensional model file for hybrid additive manufacturing. As previously discussed, hybrid additive manufacturing includes integrating a cast mass into an object being constructed with a primary device utilizing additive manufacturing, where a secondary device positions and disposes the cast mass for integration into the object. Cast selection program 200 identifying a cast for the three-dimensional model file an object to be constructed utilizing hybrid additive manufacturing can include identifying a number of casts for integration into the object, one or more material types for each of the casts, dimensions for each of the casts and a shape for each of the casts for the object being constructed with additive manufacturing. In one embodiment, cast selection program 200 identifies a single cast for integration into an object being constructed based on dimensions of the object being constructed, a shape of the object being constructed, and any received additional requirements from (204). In another embodiment, cast selection program 200 identifies multiples casts for integration into an object being constructed based on dimensions of the object being constructed, a shape of the object being constructed, and any received additional requirements from (204).

Cast selection program 200 determines a position for the cast with respect to the three-dimensional model for hybrid additive manufacturing (208). Based on any structural defined parameters in the three-dimensional model and any received additional requirements from (204), cast selection program 200 determines a position for placement of the cast with respect to the three-dimensional model for hybrid additive manufacturing. The position for the cast represents a location where cast selection program 200 instructs a secondary device to dispose the cast with respect to a body of an object being constructed with the hybrid additive manufacturing process. Cast selection program 200 can utilize a machine learning model to determine a position for the cast with respect to a body of an object to optimize structural integrity based on the structural defined parameters of the three-dimensional model. Alternatively, cast selection program 200 determines a position for the cast with respect to a body of an object based on the received additional requirement from (204). In one embodiment, cast selection program 200 receives additional requirements that specify a weighted portion of a specialized tool being constructed with the hybrid additive manufacturing process to allow for more ergonomic handling when the specialized tool is placed in a hand of a user. The weighted portion represents a cast material for integration into the specialized tool during the hybrid additive manufacturing process, where a user defines a location for the position of the cast material with respect to a body of the specialized tool. In one embodiment, cast selection program 200 queries a user to provide a position for the cast with respect to the three-dimensional model and a body of the object being constructed with the hybrid manufacturing process.

Cast selection program 200 initializes the hybrid additive manufacturing of the three-dimensional model (210). In one embodiment, cast selection program 200 initializes the hybrid additive manufacturing of the three-dimensional model by instructing a three-dimensional printer (i.e., primary device) to perform an additive manufacturing portion of the hybrid additive manufacturing process. The additive manufacturing portion includes disposing layer on top of layer of material to form a body of the object per the three-dimensional model file received in (202). Cast selection program 200 instructs the three-dimensional printer to perform an additive manufacturing portion of the hybrid additive manufacturing process until a point is reach for the integration of the cast into a partially completed body of the object. In another embodiment, cast selection program 200 initializes the hybrid additive manufacturing of the three-dimensional model by instructing a three-dimensional printer to configure into a position to accept the disposing of a cast for the object. Cast selection program 200 can utilize the cast as the base on which the three-dimensional printer builds the body of the object upon, during the hybrid additive manufacturing process. The three-dimensional printer configuring into the position to accept the disposing of the cast for the object can include relocating a mechanical arm and/or a printer nozzle away from a printing platform to create enough clearance for a secondary device (e.g., manufacturing arm) to position and dispose the cast onto the printing platform of the three-dimensional printer.

Cast selection program 200 pauses the hybrid additive manufacturing of the three-dimensional model (212). In one embodiment, subsequent to determining a hybrid additive manufacturing process has reach a point of integration of a cast into a partially constructed body of the object, cast selection program 200 pauses the hybrid additive manufacturing of the three-dimensional model by instructing the three-dimensional printer to cease the disposing of layers of material on the partially formed body. Cast selection program 200 can instruct the three-dimensional printer to configure into a position to accept the disposing of the cast for the object onto and/or adjacent to the partially constructed body of the object. Cast selection program 200 ensures that a configuration of the three-dimensional printer is such that no component of the three-dimensional printer intrudes into an operational space required for the secondary device to dispose the cast onto and/or adjacent to the partially constructed body of the object. In another embodiment, where cast selection program 200 instructs a three-dimensional printer to configure into a position to accept the disposing of a cast for the object, cast selection program 200 ensures that a configuration of the three-dimensional printer is such that no component of the three-dimensional printer intrudes into an operational space required for the secondary device to dispose the cast onto a printing platform.

Cast selection program 200 instructs a manufacturing device to position the cast at the determined location with respect to the three-dimensional model (214). The manufacturing device represents a secondary device for positioning the cast at the determine location with respect to the three-dimensional model of the object being constructed with the hybrid additive manufacturing process. An example of a manufacturing device can include a mechanical arm capable of relocating the cast from a first location (e.g., parts bin, shelf, conveyor belt) to a second location (e.g., partially printed body of the object, printing platform. The manufacturing device can operate independently of the three-dimensional printer or can be integrated into and work in conjunction with the three-dimensional printer. Furthermore, the three-dimensional printer can include one or more devices and associated components for molding a cast, where cast selection program 200 can instruct the one or more devices and the associated components to create the cast from melted material utilized by the three-dimensional printer in the layer on top of layer construction of the body of the object.

In one embodiment, cast selection program 200 instructs a manufacturing device to position a cast at the determined location on a partially printed body of an object being constructed with the hybrid additive manufacturing process. Instructing the manufacturing device to position the cast at the determined location can include instructing the manufacturing device (e.g., mechanical arm) to position over the cast at a first location, collect the cast at the first location, relocate to a second position with the partially printed body of the object, and dispose the cast onto and/or adjacent to the partially printed body of the object. In another embodiment, cast selection program 200 instructs a manufacturing device to position a cast at the determined location on a printing platform, where a portion of the body for the object is yet to be constructed via the hybrid additive manufacturing process. Instructing the manufacturing device to position the cast at the determined location can include instructing the manufacturing device to position over the cast at a first location, collect the cast at the first location, relocate to a second position over the printing platform of the three-dimensional printer, and dispose the cast onto a surface of the printing platform. In other embodiment, cast selection program 200 can instruct a casting device to initialize a cast manufacturing processing, where the cast is fully constructed by the casting device at a point in time when cast selection program 200 instructs the manufacturing device to dispose the cast at the determined position with respect to the partially printed body of the object being constructed during the hybrid additive manufacturing process.

Cast selection program 200 resumes the hybrid additive manufacturing of the three-dimensional model (216). In one embodiment, cast selection program 200 resumes the hybrid additive manufacturing of the three-dimensional model by instructing a three-dimensional printer (i.e., primary device) to continue performing the additive manufacturing portion of the hybrid additive manufacturing process. As previously discussed, the additive manufacturing portion includes disposing layer on top of layer of material to form a body of the object per the three-dimensional model file received in (202). Cast selection program 200 instructs the three-dimensional printer to continue performing the additive manufacturing portion of the hybrid additive manufacturing process until the body of the object and the hybrid additive manufacturing process is completed. In another embodiment, cast selection program 200 resumes the hybrid additive manufacturing of the three-dimensional model by instructing a three-dimensional printer (i.e., primary device) to perform the additive manufacturing portion of the hybrid additive manufacturing process on the cast disposed on the printing platform. Cast selection program 200 instructs the three-dimensional printer to perform the additive manufacturing portion of the hybrid additive manufacturing process on the cast disposed on the printing platform, until the body of the object and the hybrid additive manufacturing process is completed and a final product is constructed.

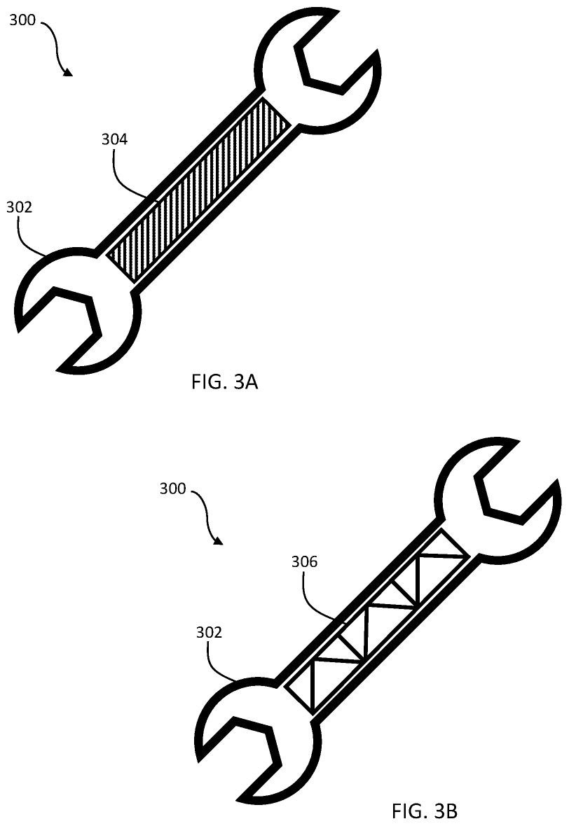

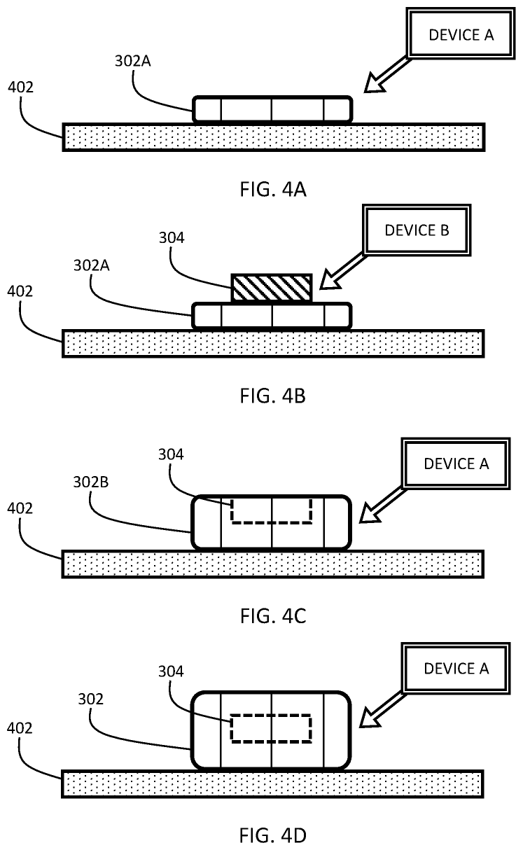

FIG. 3A depicts an illustrative example of an object constructed through additive manufacturing utilizing a solid cast portion, in accordance with an embodiment of the present invention. In this example, an object being constructed through a hybrid additive manufacturing process is wrench 300, where wrench 300 includes additive material portion 302 and solid cast portion 304. Solid cast portion 304 represents a solid material (e.g., steel, aluminum) that has been cast into a rectangular shape, where an additive manufacturing device has constructed additive material portion 302 around solid cast portion 304 to create wrench 300. The hybrid additive manufacturing process of wrench 300 with solid cast portion 304 is discussed in further detail with regards to FIGS. 4A-4D.

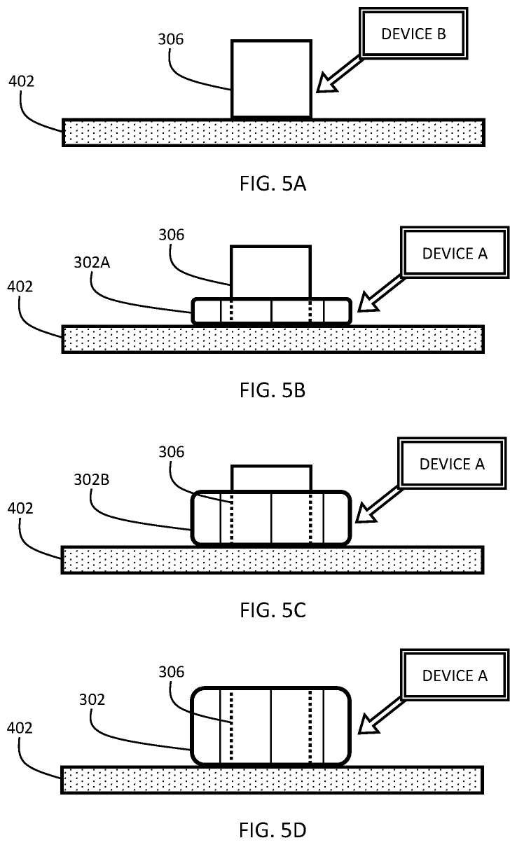

FIG. 3B depicts an illustrative example of an object constructed through additive manufacturing utilizing a truss cast portion, in accordance with an embodiment of the present invention. In this example, an object being constructed through a hybrid additive manufacturing process is wrench 300, where wrench 300 includes additive material portion 302 and truss cast portion 306. Truss cast portion 304 is constructed out of a solid material (e.g., steel, aluminum) that has been cast into a truss shape to reduce material waste, while maintaining structural integrated. An additive manufacturing device has constructed additive material portion 302 surrounding truss cast portion 306 to create wrench 300, where constructed additive material portion 302 bonded to truss cast portion 306. The hybrid additive manufacturing process of wrench 300 with truss cast portion 306 is discussed in further detail with regards to FIGS. 5A-5D.

FIG. 4A depicts an illustrative example of an object being constructed utilizing a hybrid additive manufacturing device prior to selection of a solid cast portion, in accordance with an embodiment of the present invention. In this example, cast selection program 200 receives a three-dimensional model file and any additional requirements for the hybrid additive manufacturing process, identifies a cast (i.e., solid cast portion 304) for the three-dimensional model file, and determines a position for the cast with respect to the three-dimensional model. Cast selection program 200 initializes the hybrid additive manufacturing of wrench 300 from FIG. 3A by instructing device A (i.e., additive manufacturing device) to add layer portion 302A to platform 402, where layer portion 302A represents an amount of material until solid cast portion 304 (not illustrated in FIG. 4A) is added.

FIG. 4B depicts an illustrative example of an object being constructed utilizing a hybrid additive manufacturing device subsequent to solid cast portion being selected and provided by a secondary industrial device, in accordance with an embodiment of the present invention. In this example, cast selection program 200 pauses the hybrid additive manufacturing of wrench 300 from FIG. 3A by instructing device A (i.e., additive manufacturing device) to pause operations and instructing device B (i.e., secondary manufacturing device) to position solid cast portion 304 on top of layer portion 302A of wrench 300.

FIG. 4C depicts an illustrative example of an object being constructed utilizing a hybrid additive manufacturing device to provide material around a solid cast portion, in accordance with an embodiment of the present invention. In this example, cast selection program 200 resumes the hybrid additive manufacturing of wrench 300 from FIG. 3A by instructing device A to resume constructing wrench 300 by adding layer portion 302B in areas around solid cast portion 304 of wrench 300. Layer portion 302B envelopes solid cast portion 304, such that cast portion 304 will not be visible once wrench 300 is in a final form.

FIG. 4D depicts an illustrative example of a complete object constructed utilizing a hybrid additive manufacturing device with a solid cast portion embedded in the object, in accordance with an embodiment of the present invention. In this example, cast selection program 200 completes the hybrid additive manufacturing of wrench 300 from FIG. 3A by instructing device A to ceases construction of wrench 300, where solid cast portion 304 is enveloped by additive material portion 302 and not visible with wrench 300 in the final form.

FIG. 5A depicts an illustrative example of an object being constructed utilizing a secondary manufacturing device to provide a truss cast portion to initialize construction of an object, in accordance with an embodiment of the present invention. In this example, cast selection program 200 receives a three-dimensional model file and any additional requirements for the hybrid additive manufacturing process, identifies a cast (i.e., solid cast portion 304) for the three-dimensional model file, and determines a position for the cast with respect to the three-dimensional model. Cast selection program 200 initializes the hybrid additive manufacturing of wrench 300 from FIG. 3B by instructing device B to position truss cast portion 306 on top of platform 402, where cast selection program 200 constructs wrench 300 by layering additive material portion 302 around truss cast portion 306.

FIG. 5B depicts an illustrative example of an object being constructed utilizing a hybrid additive manufacturing device to provide material around a truss cast portion, in accordance with an embodiment of the present invention. In this example, cast selection program 200 resumes the hybrid additive manufacturing of wrench 300 from FIG. 3B by instructing device A (i.e., additive manufacturing device) to resume constructing wrench 300 by adding layer portion 302A in areas around truss cast portion 306 of wrench 300. Layer portion 302A envelopes truss cast portion 306, such that truss portion 306 will be visible once wrench 300 is in a final form.

FIG. 5C depicts an illustrative example of an object being constructed utilizing a hybrid additive manufacturing device to further provide material around a truss cast portion, in accordance with an embodiment of the present invention. In this example, cast selection program 200 continues the hybrid additive manufacturing of wrench 300 from FIG. 3B by instructing device A (i.e., additive manufacturing device) to continue constructing wrench 300 by adding layer portion 302B in areas around truss cast portion 306 of wrench 300. Layer portion 302B envelopes truss cast portion 306, such that truss portion 306 will be visible once wrench 300 is in a final form.

FIG. 5D depicts an illustrative example of a complete object constructed utilizing a hybrid additive manufacturing device with a truss cast portion embedded in the object, in accordance with an embodiment of the present invention. In this example, cast selection program 200 completes the hybrid additive manufacturing of wrench 300 from FIG. 3B by instructing device A to ceases construction of wrench 300, where truss cast portion 306 is surrounded by and bounded to additive material portion 302 and visible with wrench 300 in the final form.

Embodiments of the present invention analyze a digital three-dimensional model (e.g., SLT file) of any product is to be constructed with an additive manufacturing device and based on capabilities of: (a) a casting process (b) an additive manufacturing device (c) a robotic assembling device, identify how the digital three-dimensional model is to be separated into multiple segments so that portions of the digital three-dimensional model can be manufactured with casting to optimize manufacturing time. Based on identified segmented portions of the digital three-dimensional model, embodiments of the present invention can allocate appropriate portions of digital three-dimensional model to casting and to additive manufacturing, and with an appropriate secondary device (e.g., robotic assembling system), embodiments of the present invention can construct a final product while optimizing manufacturing time. Based on the required shape and dimensions of the digital three-dimensional model to be manufactured with the casting process, embodiments of the present invention can melt a required amount of additive manufacturing filler material such that the liquid material is available for casting of those portions of the three-dimensional final product. Based on the dimensions and shape of three-dimensional model is to be manufactured and based on an amount of time required to manufacture different portions of the digital three-dimensional model with casting process and additive manufacturing, embodiments of the present inventions create appropriate manufacturing lines to construct each portion individually. The additive manufacturing device can include a secondary device and/or a robotic arm, where the secondary device and/or the robotic arm can relocate manufactured portions with casting and assemble the final product. The additive manufacturing device can modify the constructing sequence to ensure the final product is constructed in the shortest possible time. For any digital three-dimensional object to be constructed with additive manufacturing, based on a number of final products to be produced, a cost of constructing a cast for each final product, and an amount of time reduction with hybrid manufacturing, embodiments of the present invention can determine whether the object is to be manufactured with additive manufacturing or with hybrid manufacturing (i.e., additive manufacturing with cast integration).

Embodiments of the present invention can store manufacturer specified capabilities of casting that includes availability of casting sands, availability of dice, mold creation systems, and melting capability of material. Embodiments of the present invention can estimate a cost of manufacturing with casting that can include various additional costs, such as, energy needed to melt the material to liquid and preparation of sands for the casting. Embodiments of the present invention can identify the capabilities of the additive manufacturing device for any types of material selection and can estimate the time of constructing with the additive manufacturing device. Embodiments of the present invention can evaluate the quality criteria of casting and additive manufacturing, that includes items such as, porous structures and surface profiles. Embodiments of the present invention can utilize historical learning, known properties, and capabilities of casting and three-dimensional printing and can analyze the digital three-dimensional model. Based on analysis of the digital three-dimensional model, different portions of the digital three-dimensional model are analyzed to determine whether a portion of the final object can be constructed with casting. Embodiments of the present invention can identify an amount of final objects to be constructed and can determine an amount of time to construct the final objects with additive manufacturing.

Embodiments of the present invention can calculate whether construction time can be reduced with a hybrid manufacturing process (i.e., casting combined with additive manufacturing), along with any additional costs associated with utilizing two manufacturing processes. Performing cost benefit analysis provides a summary of how different portions of the final product can be constructed with casting and with additive manufacturing. Embodiments of the present invention can select a shape, size, and material for the cast to be integrated into the final object being constructed with the additive manufacturing device. A location for the cast is determined with respect to the final product as defined by the three-dimensional model and the additive manufacturing process is initialized. Embodiments of the present invention pauses the additive manufacturing processing of the final object based on the three-dimensional model and instructs a secondary device to position the cast at the determined location with respect to the final product as defined by the three-dimensional model. Subsequent to placing the cast on the partially constructed final product, embodiments of the present invention resume the additive manufacturing of the final product as defined by the three-dimensional model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a three-dimensional digital model file for construction of an object utilizing an additive manufacturing device;
responsive to receiving one or more additional requirements for the object, identifying, based on the three-dimensional digital model file and the one or more additional requirements for the object, a cast for the three-dimensional digital model file for integration into hybrid additive manufacturing of the object;
instructing, a secondary manufacturing device, to dispose the cast at a position with respect to a partially constructed object by the additive manufacturing device; and
resuming the hybrid additive manufacturing of the partially constructed object with the cast until the construction of the object is complete.

2. The computer-implemented method of claim 1, further comprising:
determining the position for placement of the cast with respect to the three-dimensional digital model file for the construction of the object;
instructing, the additive manufacturing device, to print the partially constructed object; and
responsive to printing the partially constructed object, pausing the hybrid additive manufacturing of the three-dimensional model file.

3. The computer-implement method of claim 2, wherein pausing the hybrid additive manufacturing of the three-dimensional model file further comprises:
instructing, the additive manufacturing device, to cease printing layers of a material for a body of the partially constructed object; and
instructing, the additive manufacturing device, to configure into a position to accept a disposing of the cast at the position with respect to the partially constructed object, wherein no component of the additive manufacturing device intrudes into an operational space of the secondary manufacturing device.

4. The computer-implemented method of claim 1, further comprising:
determining the position for placement of the cast with respect to the three-dimensional digital model file for the construction of the object; and
instructing, the additive manufacturing device, to configure into a position to accept a disposing of the cast at the position with respect to a printing platform, wherein no component of the additive manufacturing device intrudes into an operational space of the secondary manufacturing device.

5. The computer-implemented method of claim 1, wherein the one or more additional requirements are selected from the group consisting of: a user specified manufacturing time, a weight limit, a material type, a material utilization limit, a raw material cost limit, and a structural integrity limit.

6. The computer-implemented method of claim 1, wherein instructing, the secondary manufacturing device, to dispose the cast further comprises:
instructing, the secondary manufacturing device, to position over the cast at a first location;
instructing, the secondary manufacturing device, to collect the cast at the first location;
instructing, the secondary manufacturing device, to relocate the cast to a second position, wherein the second position is the position with respect to the partially constructed object by the additive manufacturing device.

7. The computer-implemented method of claim 1, wherein a first material of the partially constructed object is different from a second material of the cast.

8. A computer program product comprising:
one or more computer-readable storage media and program instructions stored on the one or more computer-readable storage media capable of performing a method, the method comprising:
receiving a three-dimensional digital model file for construction of an object utilizing an additive manufacturing device;
responsive to receiving one or more additional requirements for the object, identifying, based on the three-dimensional digital model file and the one or more additional requirements for the object, a cast for the three-dimensional digital model file for integration into hybrid additive manufacturing of the object;
instructing, a secondary manufacturing device, to dispose the cast at a position with respect to a partially constructed object by the additive manufacturing device; and
resuming the hybrid additive manufacturing of the partially constructed object with the cast until the construction of the object is complete.

9. The computer program product of claim 8, further comprising:
determining the position for placement of the cast with respect to the three-dimensional digital model file for the construction of the object;
instructing, the additive manufacturing device, to print the partially constructed object; and
responsive to printing the partially constructed object, pausing the hybrid additive manufacturing of the three-dimensional model file.

10. The computer program product of claim 9, wherein pausing the hybrid additive manufacturing of the three-dimensional model file further comprises:
instructing, the additive manufacturing device, to cease printing layers of a material for a body of the partially constructed object; and
instructing, the additive manufacturing device, to configure into a position to accept a disposing of the cast at the position with respect to the partially constructed object, wherein no component of the additive manufacturing device intrudes into an operational space of the secondary manufacturing device.

11. The computer program product of claim 8, further comprising:
determining the position for placement of the cast with respect to the three-dimensional digital model file for the construction of the object; and
instructing, the additive manufacturing device, to configure into a position to accept a disposing of the cast at the position with respect to a printing platform, wherein no component of the additive manufacturing device intrudes into an operational space of the secondary manufacturing device.

12. The computer program product of claim 8, wherein the one or more additional requirements are selected from the group consisting of: a user specified manufacturing time, a weight limit, a material type, a material utilization limit, a raw material cost limit, and a structural integrity limit.

13. The computer program product of claim 8, wherein instructing, the secondary manufacturing device, to dispose the cast further comprises:
instructing, the secondary manufacturing device, to position over the cast at a first location;
instructing, the secondary manufacturing device, to collect the cast at the first location;
instructing, the secondary manufacturing device, to relocate the cast to a second position, wherein the second position is the position with respect to the partially constructed object by the additive manufacturing device.

14. The computer program product of claim 8, wherein a first material of the partially constructed object is different from a second material of the cast.

15. A computer system comprising:
one or more computer processors, one or more computer-readable storage media, and program instructions stored on the one or more of the computer-readable storage media for execution by at least one of the one or more processors capable of performing a method, the method comprising:
receiving a three-dimensional digital model file for construction of an object utilizing an additive manufacturing device;
responsive to receiving one or more additional requirements for the object, identifying, based on the three-dimensional digital model file and the one or more additional requirements for the object, a cast for the three-dimensional digital model file for integration into hybrid additive manufacturing of the object;
instructing, a secondary manufacturing device, to dispose the cast at a position with respect to a partially constructed object by the additive manufacturing device; and
resuming the hybrid additive manufacturing of the partially constructed object with the cast until the construction of the object is complete.

16. The computer system of claim 15, further comprising:
determining the position for placement of the cast with respect to the three-dimensional digital model file for the construction of the object;
instructing, the additive manufacturing device, to print the partially constructed object; and
responsive to printing the partially constructed object, pausing the hybrid additive manufacturing of the three-dimensional model file.

17. The computer system of claim 16, wherein pausing the hybrid additive manufacturing of the three-dimensional model file further comprises:
instructing, the additive manufacturing device, to cease printing layers of a material for a body of the partially constructed object; and
instructing, the additive manufacturing device, to configure into a position to accept a disposing of the cast at the position with respect to the partially constructed object, wherein no component of the additive manufacturing device intrudes into an operational space of the secondary manufacturing device.

18. The computer system of claim 15, further comprising:
determining the position for placement of the cast with respect to the three-dimensional digital model file for the construction of the object; and
instructing, the additive manufacturing device, to configure into a position to accept a disposing of the cast at the position with respect to a printing platform, wherein no component of the additive manufacturing device intrudes into an operational space of the secondary manufacturing device.

19. The computer system of claim 15, wherein the one or more additional requirements are selected from the group consisting of: a user specified manufacturing time, a weight limit, a material type, a material utilization limit, a raw material cost limit, and a structural integrity limit.

20. The computer system of claim 15, wherein instructing, the secondary manufacturing device, to dispose the cast further comprises:
instructing, the secondary manufacturing device, to position over the cast at a first location;
instructing, the secondary manufacturing device, to collect the cast at the first location;
instructing, the secondary manufacturing device, to relocate the cast to a second position, wherein the second position is the position with respect to the partially constructed object by the additive manufacturing device.
